(19) United States
(12) Patent Application Publication
(10) Pub. No.: US 2005/0212990 A1
(43) Pub. Date: Sep. 29, 2005

(54) Frame for rugged mounting for bonded LCD

(76) Inventor: Ronald C. Robinder, Broad Brook, CT (US)

Correspondence Address: David A. Fox;CANTOR COLBURN LLP, 55 Griffin Road South, Bloomfield, CT, 06002, US

(21) Appl. No.: 11/086,948

(22) Filed: Mar. 22, 2005

Related U.S. Application Data
(60) Provisional application No. 60/555,241, filed on Mar. 22, 2004.

(51) Int. Cl. G02F 1/1333

(52) U.S. Cl. 349/58

(57) ABSTRACT

An exemplary embodiment of the invention is a display assembly including an LCD, a plate; and a frame. The frame includes a plurality of members interconnected to define an open interior space. The LCD is adhesively mounted to a rear side of the members. A mounting surface extends from the members into the open interior space. The mounting surface has a thickness less than a thickness of the members to define a recess for receiving the plate. A de-aired adhesive is positioned between, and bonds, the LCD and the plate.

### CROSS-REFERENCE TO RELATED APPLICATIONS

This application claims the benefit of U.S. provisional patent application Ser. No. 60/555,241, filed Mar. 22, 2004, the entire contents of which are incorporated herein by reference.

### BACKGROUND OF THE INVENTION

One problem with existing displays when enhanced by a bonded overlay is the sensitivity of the LCD to non-uniformities in the clamping pressure. Such situations arise when the user wishes to make the display water-tight or drip proof. In such cases, the LCD is typically clamped to a foam gasket to effect this seal. With stock LCD designs, the LCD is typically provided with four mounting points, two on each of the short edges of the display. When these are tightly clamped down, the LCD tends to bow upwards in the middle, resulting in non-uniform pressures applied to the glass of the display. In optically bonded displays, this non-uniform pressure is amplified at the LCD. This non-uniformity is evidenced by bright or dark spots in a uniformly excited image. Thus, a black screen may exhibit one or more bright spots or a white screen may show dark or discolored spots. These are called various things by different users, such as “glow spots” or “compression birefringence”.

### SUMMARY OF THE INVENTION

An exemplary embodiment of the invention is a display assembly including an LCD, a plate; and a frame. The frame includes a plurality of members interconnected to define an open interior space. The LCD is adhesively mounted to a rear side of the members. A mounting surface extends from the members into the open interior space. The mounting surface has a thickness less than a thickness of the members to define a recess for receiving the plate. A de-aired adhesive is positioned between, and bonds, the LCD and the plate.

The above described and other features are exemplified by the following figures and detailed description.

### BRIEF DESCRIPTION OF THE DRAWINGS

Referring now to the figures, which are exemplary embodiments, and wherein the like elements are numbered alike.

FIG. 1 is a front view of mounting frame in an exemplary embodiment of the invention.

FIG. 2 is a top view of mounting frame in an exemplary embodiment of the invention.

FIG. 3 is a cross-sectional view depicting a section of a display assembly.

FIG. 4 is a top view of an LCD and overlay plate mounted to the frame.

FIG. 5 is a cross sectional view of an LCD and overlay plate mounted to the frame.

### DETAILED DESCRIPTION OF THE INVENTION

Embodiments of the invention increase the ruggedness of an LCD display when optically bonded to an overlaying glass or plastic plate. Such an overlay may be in the form of a glass plate coated with multi-layer anti-reflection coatings to minimize surface reflections and/or to make the display more suitable

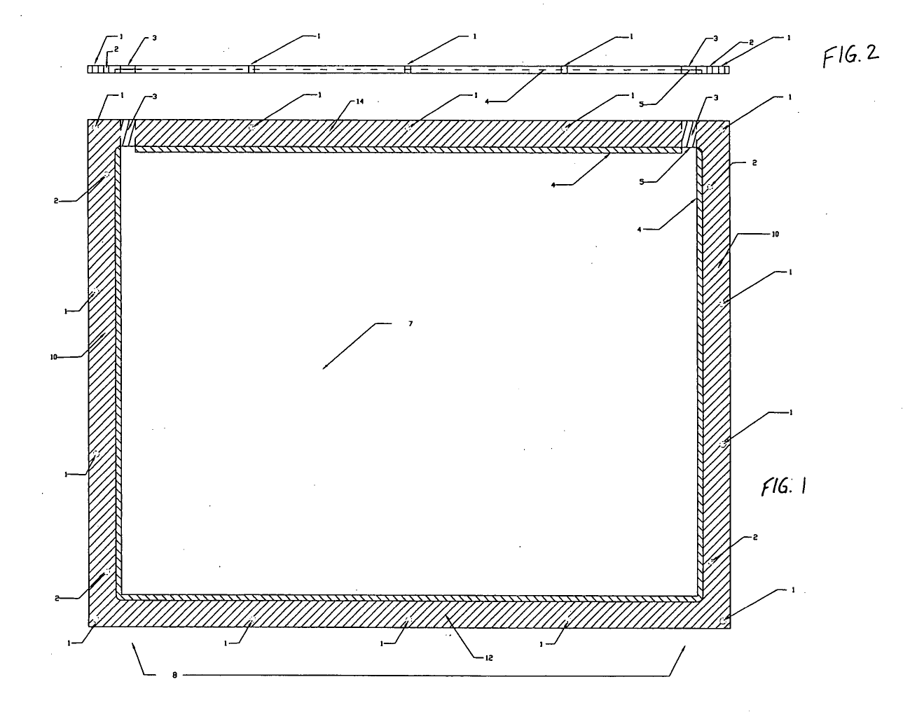

FIG. 1 is a Front view of mounting frame 8 in an exemplary embodiment of the invention. FIG. 2 is a top view of the mounting frame 8. The mounting frame 8 is generally rectangular having two side members 10, a bottom member 12 and a top member 14 defining an open interior space 7. The mounting frame 8 may be made of a metal, such as aluminum or stainless steel, or it may be made from a formed plastic, such as polyvinyl butyrate. The frame includes an open interior portion 7. A mounting surface 4 is positioned on the interior surface of the side members 10, the bottom member 12 and the top member 14. As shown in FIG. 3, the mounting surface 4 has a thickness that is less than the thickness of the members of the frame 8. This forms a recess 18 in the frame in which plate 40 rests. The recess 18 provides automatic centering of the plate (e.g., glass) which is to be bonded to the LCD 50.

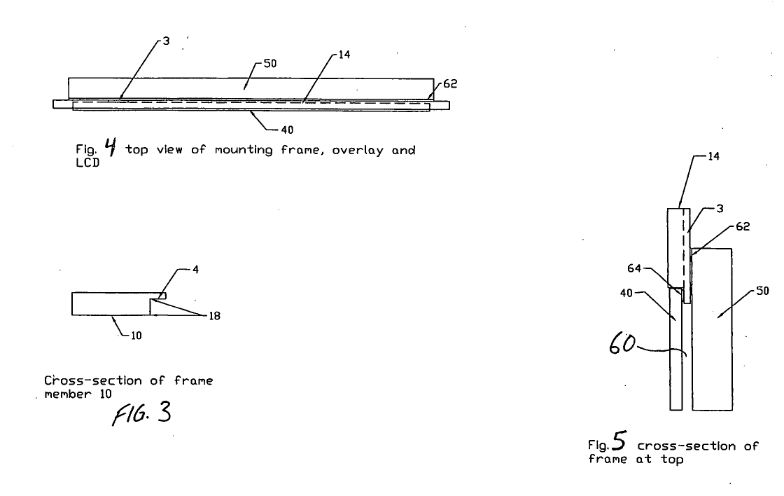

The top member 14 includes at least one filler channel 3. The filler channel 3 provides an ingress point to a cavity 60 between the LCD 50 and the plate 40 (see FIG. 5). The filler channel also extends though the mounting flange as shown at 5 in FIGS. 1 and 2. An adhesive is poured into the filler channel 3 to fill the cavity 60 with adhesive. The number of filler channels 3 may vary. Two filler channels are shown in FIG. 1. This allows injection of bonding adhesive in one filler channel 3 and escape of air from the other filler channel 3. It is understood that any number of filler channels may be used, such as one or three, and embodiments of the invention are not limited to two filler channels.

The side members 10 include alignment holes 2 to mount the LCD behind the frame without inducing pressure into the LCD. Four alignment holes 2 are shown in FIG. 1. The number and location of the holes depends on the LCD. These alignment holes 2 are used to position the LCD 50 relative to the frame 8 with minimal pressure. This prevents the LCD from flexing or bowing as in conventional designs.

A number of mounting holes 1 are provided around the entire frame 8. The mounting holes 1 are used to secure the frame 8 to a mounting bezel of a monitor once the LCD 50 and plate 40 are secured to the frame 8. Fasteners (e.g., screws) are placed through the plurality of mounting holes 1 to provide clamping pressure between the overlay glass and the bezel of a finished monitor. This provides a clamping mechanism for mounting the display assembly without stressing the LCD 50. This clamping mechanism is an integral part of the optical bond and includes, in addition to integral mounting surface 4 of controlled thickness to define the bond, a plurality of holes 1 for clamping the glass plate directly to moisture sealing foam on a monitor bezel, without affecting the LCD. The LCD is mounted to the rear of this clamp using the four alignment holes 2 provided. Non-uniform pressure is not applied to the LCD 50 because it is not necessary to use these holes to provide the water-tight seal.

Assembly of the rugged LCD will now be described with reference to FIGS. 4 and 5. An existing LCD 50 is opened from an OEM frame and is sealed to the OEM frame to prevent leakage of the liquid adhesive. The backlight may be left out or may be reattached at this time. The LCD 50 sealed into its frame is adhered to the back, flat side of the frame 8 using appropriate stand-offs and screws in alignment holes 2 as shown in FIGS. 4 and 5. A seal 62 may be formed, for example, by double-sided, adhesive tape or a non-corrosive RTV silicone adhesive applied to the rear of frame 8 to ensure there will be no leakage around the mounting surface 4.

An adhesive seal 64 may be formed on the front side of frame 8. The adhesive seal 64 may be formed, for example, by double-sided, adhesive tape or a non-corrosive RTV silicone adhesive applied to the mounting surface 4. The plate 40 (e.g., glass or plastic) is then placed into the cavity (18) of the mounting surface 4 and pressed firmly onto the adhesive seal 64. The seal 64 may be formed using a conductive adhesive. When used in conjunction with a conductive plate 40 and a conductive frame 8, this forms a barrier to EMI emissions.

The assembly of LCD 50, frame 8 and plate 40 is then placed in a holding fixture with the filler channel 3 up. The space 60 between the plate 40 and LCD 50 is then filled with a de-aired adhesive suitable for the bond. A suitable adhesive for such a bond is Dow Corning Sylgard 527. Other optically clear adhesives can be used. Care must be taken to prevent bubbles from being trapped in the adhesive while it is being poured into place. The second filler channel is left open to allow the air to be forced out of cavity 60.

The entire assembly is then cured using a thermal cycle appropriate to the LCD 50 and the adhesive being used. The filler channels 3 are back-filled with a preferably dark colored RTV to seal the adhesive in place and this is allowed to cure. The finished display assembly is then ready to mount against a monitor gasket in a final monitor bezel. The assembly is held to the monitor bezel by screws applied to the mounting holes 1. These are installed and tightened in a manner similar to bolting the head onto a high performance engine, using a cross pattern, starting with the center holes on the long edges. Care is taken to ensure proper compression of the monitor gasket to affect the liquid tight seal desired.

Embodiments of the invention prevent mounting stresses from being transferred to the LCD. The frame is firmly and uniformly clamped to the monitor bezel at numerous points around the periphery. This allows very good liquid-tight sealing of the plate, without the possibility of stressing the LCD by non-uniformly applied pressures, thereby avoiding the development of bright spots in the background

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention.

1. A display assembly comprising:
an LCD;
a plate; and
a frame, the frame including
a plurality of members interconnected to define an open interior space, the LCD adhesively mounted to a rear side of the members;
a mounting surface extending from the members into the open interior space, the mounting surface having a thickness less than a thickness of the members, define a recess for receiving the plate;
a de-aired adhesive positioned between, and bonding, the LCD and the plate.

2. The display assembly of claim 1 wherein:
the frame includes alignment holes for aligning the LCD with the frame.

3. The display assembly of claim 2 wherein:
the frame includes mounting holes for mounting the frame to a monitor bezel.

4. The display assembly of claim 1 wherein:
the frame includes a filler channel providing an ingress for the de-aired adhesive.

5. The display assembly of claim 4 wherein:
the frame includes a plurality of filler channels.

6. The display assembly of claim 1 further comprising:
a first adhesive seal between the LCD and the rear of the frame.

7. The display assembly of claim 6 wherein:
the first adhesive seal is a double-sided, adhesive tape.

8. The display assembly of claim 6 wherein:
the first adhesive seal is a non-corrosive RTV silicone adhesive.

9. The display assembly of claim 1 further comprising:
a second adhesive seal between the plate and the mounting surface.

10. The display assembly of claim 9 wherein:
the second adhesive seal is a double-sided, adhesive tape.

11. The display assembly of claim 9 wherein:
the second adhesive seal is a non-corrosive RTV silicone adhesive.

12. The display assembly of claim 1 wherein:
the mounting surface is integral with the plurality of members.

13. The display assembly of claim 1 wherein:
the plate is glass.

14. The display assembly of claim 1 wherein:
the plate is plastic.
